(19) United States
(12) Patent Application Publication
(10) Pub. No.: US 2026/0206990 A1
(43) Pub. Date: Jul. 23, 2026

(54) BEVERAGE HOLDER AND ACCESSORIES PROVIDING SPECIAL EFFECTS

(71) Applicant: Yakov BIRMAN, West Hollywood, CA (US)

(72) Inventor: Yakov BIRMAN, West Hollywood, CA (US)

(21) Appl. No.: 19/033,433

(22) Filed: Jan. 21, 2025

(51) Int. Cl. A47G 23/14; A47G 19/22; G01S 17/04

(52) U.S. Cl. CPC A47G 23/14; A47G 19/2227; G01S 17/04; A47G 2019/2238; A47G 2019/2244

(57) ABSTRACT

A beverage container can be stored in a beverage container holder apparatus or can be used with a beverage container accessory apparatus. The beverage container holder apparatus optionally includes a beverage container support, sensors to detect removal of the container, input devices to receive user input, output devices, processors, and memory. Software stored in the memory enables the device to detect container removal and trigger various actions through the output devices, such as lighting effects, sound, or haptic feedback. The beverage container accessory apparatus includes sensors and/or input devices, output devices, processors, and memory configured to trigger various actions in response to interactions with the beverage container.

### FIELD OF THE DISCLOSURE

The present disclosure generally relates to systems and method of presenting special effects associated beverage holders and/or beverage container accessories. More specifically, to special effects triggered by interactions with the beverage container.

### BACKGROUND OF THE DISCLOSURE

Beverage storage and interactions with beverage containers are conventionally focused on functional aspects of storing beverage containers or dispensing a beverage from a beverage container. To take one example, traditional wine bottle holders primarily serve functional purposes, such as storage and display of wine bottles. Beverage storage units, such as tabletop racks and wall-mounted systems, often include structures designed to securely store or display beverage containers. These devices aim to address various functional needs, such as ensuring stability and security to prevent beverage containers from tipping over or breaking and/or optimizing storage space in homes, wine cellars, bars, or retail displays. Some designs may incorporate features to account for temperature or environmental factors, such as insulation or specific orientations to maintain cork moisture of a wine bottle. However, there is a need for systems and methods that can enhance the overall experience associated with interacting with beverage containers from storage to drinking.

### SUMMARY OF THE DISCLOSURE

This disclosure relates to systems and methods systems and method of presenting special effects associated beverage holders and/or beverage container accessories. Specifically, special effects triggered by interactions with the beverage container can elevate the consumer experience and/or provide consumers unique and immersive experiences. Aspects of this disclosure aims to introduce audio, visual, and/or haptic special effects for interactions such as associated with removing a beverage container from a beverage container storage or associated with dispensing the beverage from the beverage container. The systems and method described herein incorporates one or more sensor technologies to trigger a variety of special effects. This multi-sensory approach enhances the experience of consuming beverages creating a captivating and memorable experience.

In an aspect, a smart beverage container holder is disclosed. The smart beverage container holder includes a support to hold a beverage container, one or more sensors to detect when the container is removed, and one or more output devices, like lights, speakers, or vibration motors. When the one or more sensors detect removal of the container, a processor of the smart beverage container holder's triggers one or more special effects through these output devices.

In another aspect, a method of presenting special effects involving a beverage container is disclosed. A beverage container holder is equipped with one or more sensors and one or more output devices. The method includes detecting the removal of a beverage container using the one or more sensors and, in response, activating one or more special effects through the one or more output devices.

In another aspect, a beverage stand that includes housing to partially or fully encapsulate a beverage container is disclosed. This beverage stand includes a plurality of motion apparatuses combined with one or more light sources and one or more input devices configured to detect a user input. When the one or more input devices detect the user input, a processor of the beverage stand triggers the plurality of motion apparatuses to produce a motion effect and the light sources to produce light.

In another aspect, a ring configured to attached to a beverage container is disclosed (e.g., to a neck of a bottle). The ring includes a plurality of output devices configured to produce one or more special effect, and a plurality of sensors including at least one sensor configured to detect the orientation of the beverage container. When the orientation sensor (or other sensor) detects a tilt of the beverage container to an angle conducive to pouring liquid from the beverage container, a processor of the ring triggers the one or more special effects through the plurality of output devices.

These and other aspects and features of non-limiting examples of the present disclosure will become apparent to those skilled in the art upon review of the following description of specific non-limiting examples of the present disclosure in conjunction with the accompanying drawings.

### BRIEF DESCRIPTION OF THE DRAWINGS

For the purpose of illustrating the present disclosure, the drawings show aspects of one or more examples of the disclosure. However, it should be understood that the present disclosure is not limited to the precise arrangements and instrumentalities shown in the drawings herein.

FIG. 1 illustrates an example of a computing system including one or more sensors according to some examples of the present disclosure.

FIG. 2A illustrates an example beverage stand including a sensor in contact with a beverage container according to some examples of the present disclosure.

FIG. 2B illustrates an example of detection of a removal of the beverage container from the beverage stand by the sensor in contact with the beverage container according to some examples of the present disclosure.

FIG. 3A illustrates another example of the beverage stand that includes a plurality of light sources configured to illuminate in response to the removal of the beverage container according to some examples of the present disclosure.

FIG. 3B illustrates an example response to the removal of the beverage container from the beverage stand that includes illuminating the plurality of light sources and revealing a water feature according to some examples of the present disclosure.

FIG. 3C illustrates another example response to the removal of the beverage container from the beverage stand that includes illuminating the plurality of light sources and revealing a motion apparatus including a figurine according to some examples of the present disclosure.

FIG. 4A illustrates an example of a beverage stand that includes housing that encapsulates the beverage container and a plurality of motion apparatus combined with light sources according to some examples of the present disclosure.

FIG. 4B illustrates an example response to a user input at a button disposed at the beverage stand that includes revealing the beverage container from within the housing of the beverage stand and activating the plurality of motion apparatuses including illuminating the light sources according to some examples of the present disclosure.

FIG. 5A illustrates another example of the beverage stand that includes housing that encapsulates the beverage container and a plurality of motion apparatus combined with light sources according to some examples of the present disclosure.

FIG. 5B illustrates another example response to a user input at a button disposed at the beverage stand that includes revealing the beverage container from within the housing of the beverage stand and activating the plurality of motion apparatus including illuminating the light sources according to some examples of the present disclosure.

FIG. 6A illustrates an example of a ring affixed to a beverage container that includes one or more orientation sensors and one or more output devices according to some examples of the present disclosure.

FIG. 6B illustrates an example response to a change in orientation of the beverage container detected by one or more sensors of the ring that includes a visual, haptic and/or sound output produced by the one or more output devices according to some examples of the present disclosure.

### DETAILED DESCRIPTION

In the following description of examples, reference is made to the accompanying drawings which form a part hereof, and in which it is shown by way of illustration specific examples that can be practiced. It is to be understood that other examples can be used, and structural changes can be made without departing from the scope of the disclosed examples.

This disclosure relates to systems and methods systems and method of presenting special effects associated beverage holders and/or beverage container accessories. Specifically, special effects triggered by interactions with the beverage container can elevate the consumer experience and/or provide consumers unique and immersive experiences. Aspects of this disclosure aims to introduce audio, visual, and/or haptic special effects for interactions such as associated with removing a beverage container from a beverage container storage or associated with dispensing the beverage from the beverage container. The systems and method described herein incorporates one or more sensor technologies to trigger a variety of special effects. This multi-sensory approach enhances the experience of consuming beverages creating a captivating and memorable experience.

In an aspect, a smart beverage container holder is disclosed. The smart beverage container holder includes a support to hold a beverage container, one or more sensors to detect when the container is removed, and one or more output devices, like lights, speakers, or vibration motors. When the one or more sensors detect removal of the container, a processor of the smart beverage container holder's triggers one or more special effects through these output devices.

In another aspect, a method of presenting special effects involving a beverage container is disclosed. A beverage container holder is equipped with one or more sensors and one or more output devices. The method includes detecting the removal of a beverage container using the one or more sensors and, in response, activating one or more special effects through the one or more output devices.

In another aspect, a beverage stand that includes housing to partially or fully encapsulate a beverage container is disclosed. This beverage stand includes a plurality of motion apparatuses combined with one or more light sources and one or more input devices configured to detect a user input. When the one or more input devices detect the user input, a processor of the beverage stand triggers the plurality of motion apparatuses to produce a motion effect and the light sources to produce light.

In another aspect, a ring configured to attached to a beverage container is disclosed (e.g., to a neck of a bottle). The ring includes a plurality of output devices configured to produce one or more special effect, and a plurality of sensors including at least one sensor configured to detect the orientation of the beverage container. When the orientation sensor (or other sensor) detects a tilt of the beverage container to an angle conducive to pouring liquid from the beverage container, a processor of the ring triggers the one or more special effects through the plurality of output devices.

These and other aspects and features of non-limiting examples of the present disclosure will become apparent to those skilled in the art upon review of the following description of specific non-limiting examples of the present disclosure in conjunction with the accompanying drawings.

In some examples, a computing system is included configured to receive inputs and/or produce one or more outputs according to the example inputs described herein below. In some examples, a beverage container holder or beverage container accessory (e.g., ring) is described herein including the computing system. The computing system can be built into, attached to, and/or disposed upon the example beverage holder.

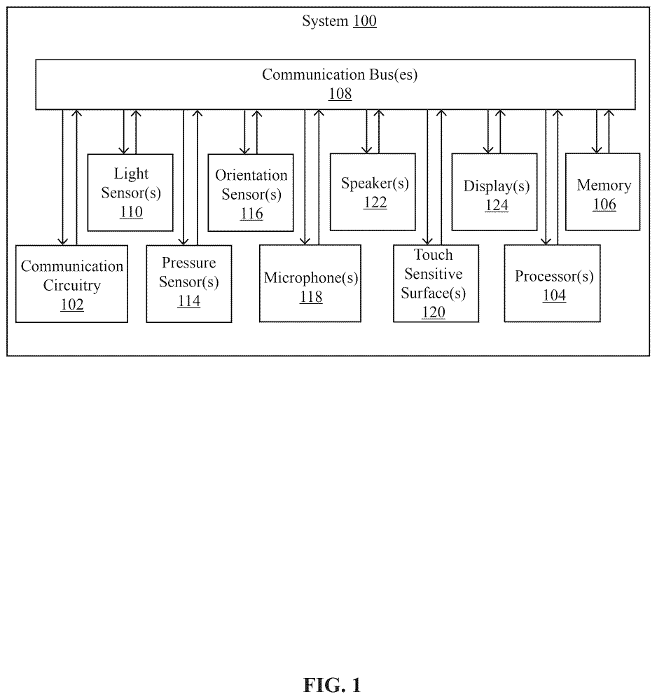

For example, FIG. 1 illustrates an example computing system (herein referred to as system 100) for use with a beverage container holder or accessory, according to examples of the disclosure. System 100 includes memory, one or more processors 104, a sensor or a plurality of sensors, and one or more output devices.

For example, system 100 can include various sensors such as one or more buttons, one or more touch-sensitive surfaces 120 (e.g., touch sensitive controls), one or more microphones 119, one or more motion or orientation sensors 116, one or more force or pressure sensors 114, and/or one or more light sensors 110. These sensors can be used to detect interactions with the beverage container and are described in more detail below.

For example, system 100 can include various output devices such as displays, light emitters (also referred to as light sources), haptic output generators (e.g., vibration motors), audio output devices (e.g., speakers or other digital, analog, mechanical, or other audio output devices including bells, chimes, or other instruments), or other motorized output devices such as animatronic figurines, water features, or a variety of object(s) configured to produce special effects. These output devices can be used to present special effects in response to detecting interactions with the beverage container and are described in more detail below.

System 100 can include memory 106 comprising, but not limited to, random access memory (RAM), read-only memory (ROM), Flash memory, an erasable programmable read-only memory (EPROM), an electrically erasable programmable read-only memory (EEPROM) or other types of memory or storage. Additionally, system 100 can include one or more processors 104 such as a central processing unit (e.g., CPU), graphics processing unit (e.g., GPU), programmable logic device (e.g., PLD), complex programmable logic device (e.g., CPLD), field programmable gate array (e.g., FPGA), or microcontroller, among other possibilities.

It should be apparent that the architecture shown in FIG. 1 is only one example architecture of system 100, and that the computing system could have more or fewer components than shown, or a different configuration of components. The components shown in FIG. 1 can be implemented using hardware, software, firmware or any combination thereof. Communication between components of the architecture of system 100 can be achieved using one or more communication buses 108.

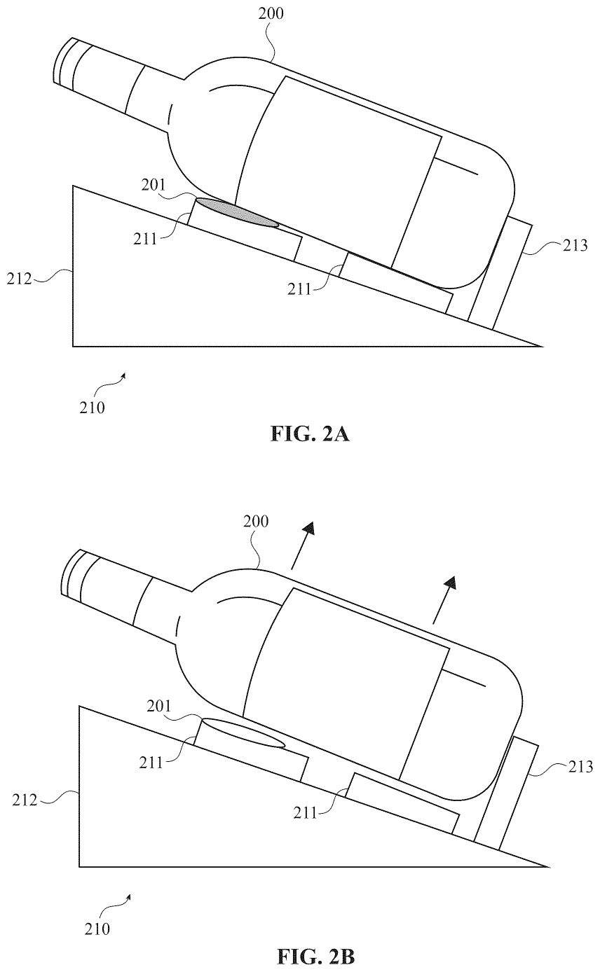

In some examples, system 100 includes a battery or other power source to provide a power supply. In some examples, system 100 includes communication circuitry 102 to provide wired or wireless communication (e.g., cellular, Bluetooth, Wi-Fi, etc.) with one or more secondary computer systems possessing one or more characteristics of system 100. For example, system 100 is optionally provided within a beverage container holder (described in further detail with reference to FIG. 2A) or accessory and system 100 optionally transmits, via a Bluetooth connection, a command to a secondary device including one or more output devices an indication of a trigger detected by the one or more sensors. As another example, system 100 is optionally provided within a beverage container holder (described in further detail with reference to FIG. 2A) or accessory and system 100 optionally transmits, via a Bluetooth connection, output from sensors of the system to a secondary computing device to process the sensor output and determine whether to trigger the special effects described herein. In some examples, the communication circuity 102 provides wireless communication to an application included in software at a secondary computer system. For example, the secondary computer system optionally corresponds to a mobile phone that includes software (e.g., application) configured to provide one or more commands to system 100 in response to an input provided by a user of the mobile phone. In some examples, the one or more commands transmitted by the secondary computer system cause system 100 to produce one or more special effects discussed in further detail below with references to FIGS. 2A-6B.

System 100 can include one or more light sensors 110, one or more pressure sensors 114 (or force sensors), one or more orientation sensors 116 and one or more microphones 118 for receiving inputs provided by a user and/or detecting interaction with a beverage container and performing functions based on the inputs as described in further detail below. For example, one or more pressure sensors 114 can be configured to receive a pressure input and display this input at one or more displays 124 (e.g., a Liquid-Crystal Display (LCD)) via one or more communication buses 108. It is understood that although some examples of the disclosure may be described with reference to LCD displays, the scope of the disclosure is not so limited and can extend to other types of displays, such as Light-Emitting Diode (LED) displays, including Organic LED (OLED), Active-Matrix Organic LED (AMOLED) and Passive-Matrix Organic LED (PMOLED) displays. In some examples, system 100 may optionally use one or more of the listed sensors herein to receive the inputs provided by the user and/or detect interaction with the beverage container and perform functions based on the input according to some examples of this disclosure. For example, one or more microphones 118 are optionally be configured to receive a user voice command, and in response, provide an audio output from one or more speakers 122 via one or more communication buses 108. Optionally, these voice commands can be provided in any language (e.g., English, Spanish, Chinese, Korean, Japanese, etc.) spoken or otherwise, and the one or more processors can be configured to process the inputs (e.g., optionally using translation) to invoke a special effect response.

Note that one or more of the functions described herein, can be performed by firmware stored in memory 106 (or multiple memories) and executed by one or more processors 104. For example, the firmware stored in memory 106 can include predetermined settings and/or customizable settings configured by a user to optionally influence the function the firmware performs according to some examples of this disclosure described in further detail below. In some examples, a predetermined threshold or setting optionally corresponds to a pressure input threshold that, when detected by the one or more pressure sensors 114, presents a visual indication displayed at the one or more displays 124. The firmware can also be stored and/or transported within any non-transitory computer-readable storage medium for use by or in connection with an instruction execution system, apparatus, or device, such as a computer-based system, processor-containing system, or other system that can fetch the instructions from the instruction execution system, apparatus, or device and execute the instructions. In the context of this disclosure, a “non-transitory computer-readable storage medium” can be any medium (excluding signals) that can contain or store the program for use by or in connection with the instruction execution system, apparatus, or device. The computer-readable storage medium can include, but is not limited to, an electronic, magnetic, optical, electromagnetic, infrared, or semiconductor system, apparatus or device, a portable computer diskette (magnetic), a random access memory (RAM) (magnetic), a read-only memory (ROM) (magnetic), an erasable programmable read-only memory (EPROM) (magnetic), a portable optical disc such a CD, CD-R, CD-RW, DVD, DVD-R, or DVD-RW, or flash memory such as compact flash cards, secured digital cards, USB memory devices, memory sticks, and the like.

The firmware can also be propagated within any transport medium for use by or in connection with an instruction execution system, apparatus, or device, such as a computer-based system, processor-containing system, or other system that can fetch the instructions from the instruction execution system, apparatus, or device and execute the instructions. In the context of this document, a “transport medium” can be any medium that can communicate, propagate or transport the program for use by or in connection with the instruction execution system, apparatus, or device. The transport medium can include, but is not limited to, an electronic, magnetic, optical, electromagnetic or infrared wired or wireless propagation medium.

In some examples, such as illustrated by FIG. 2A, a beverage holder 210 is provided including beverage container 200 disposed on an upper portion of beverage holder 210. In some examples, the beverage holder 210 includes a computer system (e.g., such as system 100) configured to process and respond to inputs provided by beverage container 200.

In some examples, the beverage holder 210 comprises a base, one or more support members, and a beverage container-receiving portion (or bottle-receiving portion for bottle-type beverage containers). The base is configured to provide stability and support to the holder, with or without a non-slip surface or weighted material to prevent movement or tipping. A support member extends upward or at an angle from the base and is shaped to engage and secure the beverage container such as a standard wine bottle. In some examples, the bottle-receiving portion, integrated into or connected to the support member, optionally includes a contoured surface, groove, or cutout configured to cradle the body and/or neck of the beverage container 200, thereby maintaining the bottle in a secure and visible position. The holder may be constructed from wood, metal, plastic, acrylic, or other suitable materials, or a combination thereof. The structure may incorporate aesthetic or functional variations, including but not limited to decorative elements, inclined orientations, or configurations for vertical or horizontal display. Please note that the orientation of the beverage container 200 disposed at beverage holder 210 is not limited to the orientations as illustrated by FIGS. 2A-2B but may be placed at the beverage holder 210 in a horizontal orientation, vertical orientation or any other variety of orientations herein.

In some examples, such as illustrated by FIG. 2A, the beverage holder 210 is comprised of beverage container supports configured to contact a portion of the beverage container 200. For example, the beverage holder 210 includes base structure 212 that optionally is disposed on a surface, such as a countertop. In some examples, base structure 212 includes an upper container supports 211 configured to contact the body of beverage container 200 and lower container support 213 configured to contact a base of beverage container 200. It should be noted that the contact points of beverage container 200 are not limited to the contact points as illustrated by FIG. 2A and beverage container 200 may be optionally arranged in a variety of positions conducive to stably supporting the beverage container 200 upon beverage holder 210. For example, the base structure 212, as illustrated by FIG. 2A, is at such an angle such that the neck of the beverage container 200 is above the base of the beverage container 200 in contact with lower container support 213.

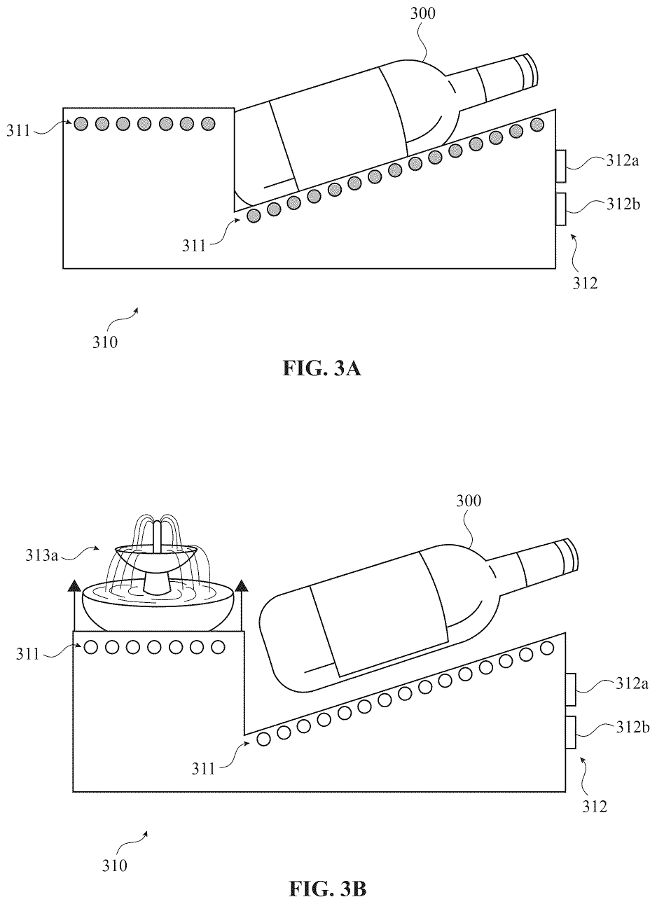

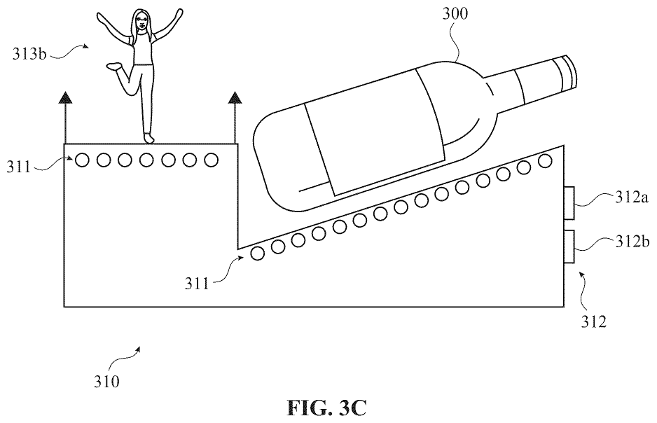

In some examples, the beverage container 200 is optionally in contact with or a characteristic of the beverage container 200 is detectable by one or more sensors configured to detect the beverage container 200. For example, as illustrated by FIG. 2A, sensor 201 is disposed at a top face of upper container supports 211. In some examples, the sensor 201 corresponds to any of the input sensors described with respect to system 200 (e.g., one or more light sensors 110, one or more pressure sensors 114, one or more touch sensitive surfaces 120). The sensors optionally detect the presences and/or removal of the beverage container 200. The presences and/or removal are optionally determined based on one or more criteria. In some examples, the sensor 201 optionally includes a threshold criterion such that presence of the beverage container 200 in the beverage holder 210 is determined when satisfied by contact or sufficient pressure/force of contact of the beverage container with sensor 201 (and that is not satisfied when the beverage container 200 is removed). For example, sensor 201 optionally corresponds to one or more pressure sensors (e.g., pressure sensors 114) that detects pressure exerted by beverage container 200, and transmits information, via one or more communication buses 108, to one or more processors 104 indicating that the beverage container 200 has been placed on (or removed from) beverage holder 210. This pressure threshold criterion can correspond to a weight of a particular beverage container, such as a wine bottle, and in some cases, may include a pressure threshold criteria corresponding to a weight of a beverage container that contains any range of liquid (e.g., completely full, half-full, empty, etc.). In some examples, sensor 201 is disposed at the lower container support 213, and detects pressure exerted by the base of the beverage container 200 when placed on the beverage holder 210. In some examples, the sensor 201 corresponds to a light sensor (e.g., one or more light sensors 110) configured to detect the absence of light or a decrease in light (e.g., corresponding to a light level below a threshold light level) and/or detect reflected light emitted by the light sensor indicative of the beverage container being place on the beverage holder 210 (and/or removed from the container when light increases above a threshold light level). Sensor 201 can additionally be configured to detect the presence of reflected light emitted by sensor 201 (e.g., proximity sensor, LiDAR sensor, etc.), such that when a reflected light intensity corresponding to the placement of the beverage container 200 is detected, the beverage holder 210 does not produce a special effect as discussed in further detail below with reference to FIGS. 3A-3C. The aforementioned examples of sensors as illustrated by FIG. 2A may optionally be configured to detect a removal of the beverage container 200 and perform one or more functions/actions in response, such as discussed in further detail below with respect to FIG. 2B.

As illustrated by FIG. 2B, beverage container 200 may be removed from beverage holder 210, optionally detected by sensor 201. For example, as the beverage container 200 is removed from the beverage holder 210, a disengagement occurs. The beverage container 200 neck, previously cradled securely by the container base structure 212 and lower container support 213, begins to slide free as upward as a forward motion is applied. In some examples, the removal of beverage container 200 may fail to satisfy the previously discussed threshold criterion (or multiple criteria) as discussed above with reference to FIG. 2A. For example, the sensor 201 may correspond to a pressure sensor that, when the beverage container 200 is removed, detects that a pressure threshold criterion is no longer satisfied. Sensor 201 may optionally in response to detecting that the pressure threshold criteria is no longer satisfied transmit instructions to a processor (e.g., one or more processors 104) to perform actions such as illustrated and described in further detail below with reference to FIGS. 3A-3C. The aforementioned threshold criteria optionally correspond to a light level detected by a light sensor (e.g., one or more light sensors 110), wherein a low-light level (below a threshold) indicates that the beverage container 200 is placed on the supports of the beverage holder 320. In some examples, such as illustrated by FIG. 2B, a higher light level may be optionally detected by the sensor 201 when the beverage container 200 is removed from the beverage holder 210. The removal of the beverage container 200 in this instance allows for light to be detected by the sensor 201, thus failing to meet the threshold criteria (e.g., low-light level).

As discussed above, beverage holder 210 may optionally perform one or more actions in response to a detection of the removal of the beverage container 200 (e.g., a bottle). In some examples, the firmware performs a predetermined action as illustrated below in detail with reference to FIGS. 3A-3C.

As illustrated by FIG. 3A, a beverage holder 310 is presented including one or more characteristics that are the same as or similar to that of the beverage holder 210 discussed above. For example, beverage holder 310 may include a beverage container 300 disposed on an angled surface conducive to maintaining the beverage container 300 upon the beverage holder 310. In some examples, the beverage holder 310 includes support structures and sensors such as is illustrated in FIGS. 2A-2B. For example, beverage holder 310 optionally includes a sensor including one or more characteristics of sensor 201 configured to detect the presence of beverage container 300. As illustrated by FIG. 3A, when the threshold criterion is satisfied, and as illustrated by FIG. 3A, a plurality of light sources 311 are optionally not be illuminated. In some examples, in response to the threshold criterion not being satisfied, the plurality of light sources 311 are optionally illuminated or a characteristic of the illumination is changed (e.g., flashing, changing color, changing intensity, etc.).

Beverage holder 310 may, in some cases, perform functions as dictated by the firmware discussed above with reference to FIG. 1 in accordance to an input directed at control panel 312. In some examples, as illustrated by FIG. 3A, control panel 312 may include input device 312a and input device 312b. In some examples, such as illustrated by FIG. 3A, input devices 312a and 312b are optionally a button configured to receive a user input. In some examples, input devices 312a and 312b correspond to a light sensor, a pressure sensor, a microphone, a touch panel, other suitable sensors, or any combination of input devices such as those illustrated by FIG. 1 herein (e.g., one or more light sensors 110, one or more pressure sensors 114, one or more microphones 118, one or more touch sensitive surfaces 120). In some examples, input device 312a and/or input device 312b are optionally configured to activate/deactivate beverage holder 310, such as discussed in further detail below with reference to FIG. 3B.

For example, as illustrated by FIG. 3B, one or more of the input devices 312a and 312b of control panel 312 may optionally have received an input (such as a user input), that causes one or more functions to be performed by beverage holder 310 in response to a removal of the beverage container 300. In some examples, the beverage holder 310 is in an “active” mode corresponding to a detection period (e.g., when sensors are actively detecting inputs) according to an input (e.g., a first user input) directed at any of the input devices 312a/312b of the control panel 312. In response to the beverage container 300 being removed from beverage holder 310, the plurality of light sources 311 may be activated (e.g., illuminated in a pattern or in tandem), optionally accompanied by a reveal of an output device 313a including one or more objects configured to cause motion. For example, as illustrated by FIG. 3B, the output device 313a may optionally correspond to a water feature, such as a fountain. This fountain optionally actively produces water via a pump from a reservoir or water source such as illustrated by FIG. 3B, but output device 313a in some instances may produce the fountain without water (i.e., “dry”). In some examples, in response to the removal of the beverage container 300, the output device 313a is optionally not revealed when one or more of the input devices 312a and 312b have received an input (e.g., a second user input) transitioning to an “inactive” mode (e.g., end of the detection period).

In some examples, the fountain, as illustrated by FIG. 3B, may be activated via a build-in timer, such that when a predetermined period of time has elapsed, the fountain may be revealed and/or actively produce water. This built-in timer is optionally activated via a user input. Additionally, a time value for the built-in timer is optionally set via the user input, such as for setting the predetermined period of time. In some examples, the built-in timer activates the output device 313a and/or the plurality of light sources 311 once the predetermined period of time has elapsed. In some examples, the built-in timer is configured such that once the output device 313a and/or the plurality of light sources 311 are activated, the processor of the beverage holder 310 ceases the special effects produced by the output device 313a and/or the plurality of light sources 311 once the predetermined period of time has elapsed as captured by the built-in timer. In some example, the timing functionality is built into the one or more processors 104.

In some examples, the plurality of light sources 311 may be illuminated in response to the removal of the beverage container 300, and the absence of an input directed at the control panel 312 optionally causes the output device 313a to not be revealed. These plurality of light sources 311 illuminated in response to the removal of the beverage container 300 may be of any color, brightness, intensity, pattern, etc. as dictated by the firmware stored in memory 106 and executed by one or more processors 104, or by the user input directed at the control panel 312. In addition, in tandem with the reveal of the output device 313a and the illumination of the plurality of light sources 311, the beverage holder 310 optionally produces a noise/sound effect as dictated by the firmware. This noise/sound effect may be music of any genre and/or any sound, including a human voice in one or more languages (e.g., any language), and adjusted in volume as determined by the firmware and/or a user input. In some examples, the sound effect includes outputting public broadcasts from radio, streaming channels, and/or music websites.

In some examples, the special effects produced by the output device 313a and/or the plurality of light sources 311 are controlled via an application stored at a secondary device, such as discussed above with reference to the system 100. In this example, the secondary device (e.g., mobile phone) optionally detects a user input at the application and transmits one or more commands to the beverage holder 310 to engage the device (e.g., transitioning into the “active” mode), activate/deactivate the plurality of light sources 311, activate/deactivate the output device 313a, or any combination thereof. Please note that the breadth of functions controllable by the application stored at the secondary device is not limited to the aforementioned list and may be further configured to modify a variety of functions of the components of beverage holder 310 described above.

FIG. 3C illustrates another example of a beverage holder 310 revealing an output device 313b corresponding to a figurine in response to the removal of the beverage container 300. In some examples, as similarly discussed above, the reveal of output device 313b in response to the removal of the beverage container 300 is contingent on the beverage holder 310 being in the “active” mode according to the input directed at the control panel 312. In some examples, the reveal of the output device 313b includes one or more actions performed by the figurine. In some examples, the output device 313b includes an object configured to cause motion (e.g., one or more actions), such as a dancing motion as illustrated by FIG. 3C or other suitable motions (e.g., rotation, etc.). In some examples, the one or more actions performed by the figurine (e.g., dancing motion) encompasses executing a variety of motions, including but not limited to rotational, oscillatory, translational, and articulated limb movements. The motion of the figurine may be pre-programmed, user-controlled, or generated in response to external stimuli such as music, ambient sounds, or sensor inputs (e.g., sensor 201 or other sensors described herein). In addition, the figurine may optionally be adapted to support different dance styles, tempos, and motion sequences as dictated by the firmware and/or a user input. In some examples, the one or more actions performed by the figurine can be predetermined by the firmware of the beverage holder 310. For example, as illustrated by FIG. 3C, in response to the removal of the beverage container 300, the output device 313b reveals the figurine in an upward ascending motion as indicated by the arrows. With this reveal of the figurine, the beverage holder 310 may optionally illuminate the plurality of light sources 311 in a similar manner as described above with reference to FIG. 3B. In some examples, the one or more actions of the output device 313b can be optionally synchronized to one or more secondary beverage holders (e.g., via communication circuity 102) to perform the one or more actions simultaneously. These secondary beverage holders previously discussed may optionally be similar to or identical to beverage holder 310 that are each synchronized with beverage holder 310 to optionally perform the same one or more actions as the one or more actions of the output device 313b. In some examples, the output device 313b optionally comprises of a plurality of figurines performing the one or more actions.

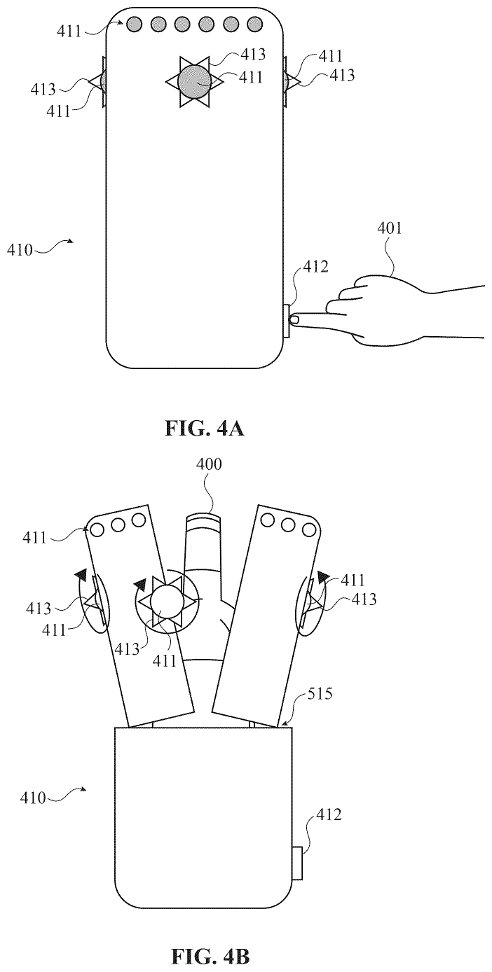

In some examples, such as illustrated by FIG. 4A, a beverage holder 410 is provided including beverage container 400 (pictured in FIG. 4B) disposed within a cylindrical-shaped housing cavity of beverage holder 410. The beverage holder 410 optionally includes a tube-like structure designed to fit snugly around the beverage container 400, such as a standard wine bottle as illustrated in FIG. 4B below. Made from durable materials like stainless steel or wood (or other suitable materials), the beverage holder 410 may provide insulation to maintain the beverage container 400 temperature and protection from impacts. In some examples, the beverage holder 410 includes a computer system (e.g., such as system 100) configured to process and respond to inputs at input device 412 provided by hand 401. In some examples, such as illustrated by FIG. 4A, an upper outer surface of the beverage holder includes a plurality of light sources 411 encircling the perimeter. A subsection of the plurality of light sources 411 are included at the center of the motion apparatuses 413, such that in response to the input provided by hand 401 directed at input device 412, the subsection of the plurality of light sources 411 and the motion apparatuses 413 are activated as illustrated below with reference to FIG. 4B. In some examples, the motion apparatuses 413 correspond to a star-shaped motion apparatus as illustrated in FIG. 4A configured to perform a spinning motion as discussed in further detail below with reference to FIG. 4B. For example, as shown in FIG. 4A, the housing of beverage holder 410 includes the star-shaped motion apparatuses 413 (e.g., four star-shaped motion apparatuses) on each face of the cylindrical-shape of the housing of the beverage holder 410. In some examples, such as shown in FIG. 4A, the input device 412 corresponds to a button configured to receive the input provided by hand 401. It is understood that the star-shaped motion apparatus is one non-limiting example of a motion apparatus. In some examples, the motion apparatus is flower shaped. In some examples, the input device 412 includes one or more characteristics of the input devices 312a/312b as described above with reference to FIGS. 3A-3C (e.g., one or more light sensors 110, one or more pressure sensors 114, one or more microphones 118, one or more touch sensitive surfaces 120).

In response to the input provided by hand 401 as shown in FIG. 4A, the beverage holder 410 may open via hinge 415 (or other suitable mechanism) to reveal beverage container 400 as illustrated by FIG. 4B. In some examples, the portions of the housing of beverage holder 410 open outward like “petals” of a flower. In some examples, the plurality of light sources 411 and motion apparatuses 413 may be activated when the beverage container 400 is revealed. These plurality of light sources 411 may be illuminated in any color, brightness, intensity, pattern as dictated by the firmware and/or a user input. In one non-limiting example, such as illustrated by FIG. 4B, the action performed by motion apparatuses 413 is a spinning motion. This spinning motion may be performed during, after, or prior to the hinge 415 revealing the beverage container 400 at any speed according to the firmware of the beverage holder 410 and/or a user input. In some examples, the motion apparatuses 413 is configured to executing a diverse range of movements beyond the depicted spinning action as illustrated by FIG. 4B. Depending on the design and configuration of the beverage holder 410, the motion apparatuses 413 may facilitate oscillatory motion, linear translation, or complex multi-axis movements. For example, the motion apparatuses 413 could incorporate pivoting or tilting mechanisms to enable angular adjustments or include extendable components that allow for controlled expansion and contraction. In some examples, the motion apparatuses 413 may integrate programmable motion patterns (e.g., implemented by one or more processors 104), enabling customized sequences that achieve a desired special effect. In some examples, the plurality of light sources 411 may be illuminated and the motion apparatuses 413 may spin in tandem, staggered, or any combination thereof. In some examples, the beverage container 400 may produce a noise/sound effect, via on audio speaker, in response to the hinge 415 revealing beverage container 400 such as described above with reference to system 100 (e.g., one or more speakers 122). This noise/sound effect may optionally correspond to music set at any volume that the user may select and/or is programmed into the firmware of the beverage holder 410. This music may be of any genre and/or sound including, but not limited to, a human voice of any language. In some examples, the special effects produced by beverage holder 410 are initiated and/or ceased according to a predetermined period of time dictated by a timer (e.g., built-in or implemented by a processor) possessing one or more characteristics of the timer of beverage holder 310. In some examples, the noise/sound produced as described above are controlled via an application stored at a secondary device such as discussed above with reference to beverage holder 310.

In some examples, hinge 415 may open an upper portion of the housing of the beverage holder 410 via a multi-hinge (e.g., dual-hinge) system affixed to a central point or within a threshold distance of a center point of the housing of the beverage holder 410, such as shown in FIG. 4B. In some examples, the hinge 415 may be a single-hinge system affixed to a left-side portion or right-side portion of the housing of the beverage holder 410 that is configured to open the upper portion of the beverage holder 410 in such a way that the beverage container 400 is at least partially revealed.

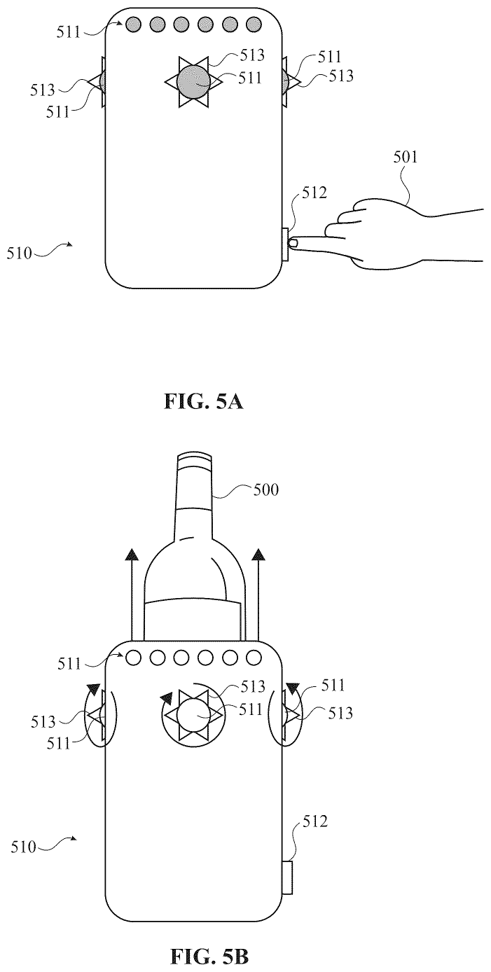

In some examples, the housing of the beverage holder 410 may reveal the beverage container 400 in an alternative manner such that hinge 415 is not necessary, such as discussed in further detail below with reference to FIGS. 5A-5B.

FIGS. 5A-5B illustrates another method of revealing beverage container 400 (beverage container 500 in FIGS. 5A-5B) from the housing of beverage holder 410 (labeled beverage holder 510 in FIGS. 5A-5B). In some examples, the beverage holder 510 is the same as or includes one or more characteristics of beverage container 410, such as a plurality of light sources 511 (e.g., plurality of light sources 411), motion apparatuses 513 (e.g., motion apparatuses 413), and/or input device 512 (e.g., input device 412). Additionally or alternatively to using hinge 415 as discussed above, beverage holder 510 may raise beverage container 500 from within a cavity of the housing of the beverage container 500 to reveal at least a portion of the beverage container 500. In some examples, the beverage holder 510 reveals the beverage container 500 while simultaneously illuminating the plurality of light sources 511 and/or activating the motion apparatuses 513. These motion apparatuses may perform a variety of actions/motions at a variety of speeds in a similar manner as described above with reference to FIGS. 4A-4B. In some examples, the cavity within the beverage holder 510 includes an opening at the upper portion of the housing of the beverage holder 510 that is at a size conducive to allowing the beverage container 500 to be raised up when revealing the beverage container 500 from inside the cavity. In some examples, the variety of actions/motions produced by beverage holder 510 are initiated and/or ceased according to a predetermined period of time detected by a timer (e.g., built in or otherwise implemented) possessing one or more characteristics of the timer of beverage holder 310. In some examples, the variety of actions/motions as described above are controlled via an application stored at a secondary device such as discussed above with reference to beverage holder 310 and beverage holder 410.

An inner mechanical system may be provided to raise the beverage container 500 from within the cavity of the beverage holder 510 to the outside can utilizing various mechanisms such as telescoping columns, scissor lifts, screw jacks, or hydraulic/pneumatic lifts. In some examples, the inner mechanical system consists of a sturdy base plate at the bottom of the cavity of the beverage holder 510, which anchors the mechanism, and a lift platform that directly supports the beverage container 500 being raised. The vertical motion (e.g., raising motion) is achieved through components like telescoping columns, which extend upward; scissor lift mechanisms, which expand and contract using interconnected folding supports; lead screws or actuators for precise and controlled motion; or hydraulic pistons, which use pressurized fluid for smooth and heavy lifting. The vertical motion may be powered by a drive mechanism, such as an electric motor, a hydraulic pump, or a manual crank for simpler operations. In some examples, guides and tracks are often incorporated to ensure the lift platform remains stable and aligned during movement. Automated systems may include sensors to monitor position and controls for precise operation. When activated, such as when the input provided by hand 501 is detected, the drive mechanism powers the vertical motion system, causing the lift platform to rise along the guides until it reaches the upper limit, positioning the beverage container 500 outside the beverage holder 510 as illustrated by FIG. 5B. In some examples, the drive mechanism causes the lift platform to rise a certain percentage (e.g., 25%, 50%, 75%, etc.), which is optionally programmable by the user. Safety features, such as locking mechanisms to prevent unintended lowering and overload sensors to protect against excessive weight, may optionally be included. It should be understood that the aforementioned drive mechanism described above is not limited to causing the lift platform to rise in a vertical fashion and may optionally cause the lift platform to move in a horizontal, circular, and/or multiple directions simultaneously.

Although illustrated separately for ease of description, in some examples, the features herein can be combined. For example, the beverage holder 210 or 310 of FIGS. 1-3C can be modified to include a motor that causes the beverage container and/or the beverage holder to present the beverage container in a vertical orientation in response to input and/or interaction. In some examples, once in the vertical orientation, a lift mechanism causes the bottle to be revealed and/or lifted as described in the context of FIGS. 4A-4B and 5A-5B. Additionally, it is understood that, in some examples, one or more of special effects described herein (e.g., sound, light, movement, haptics, etc.) can be implemented once triggered serially, partially concurrently, fully concurrently, and in a predetermined pattern or randomly.

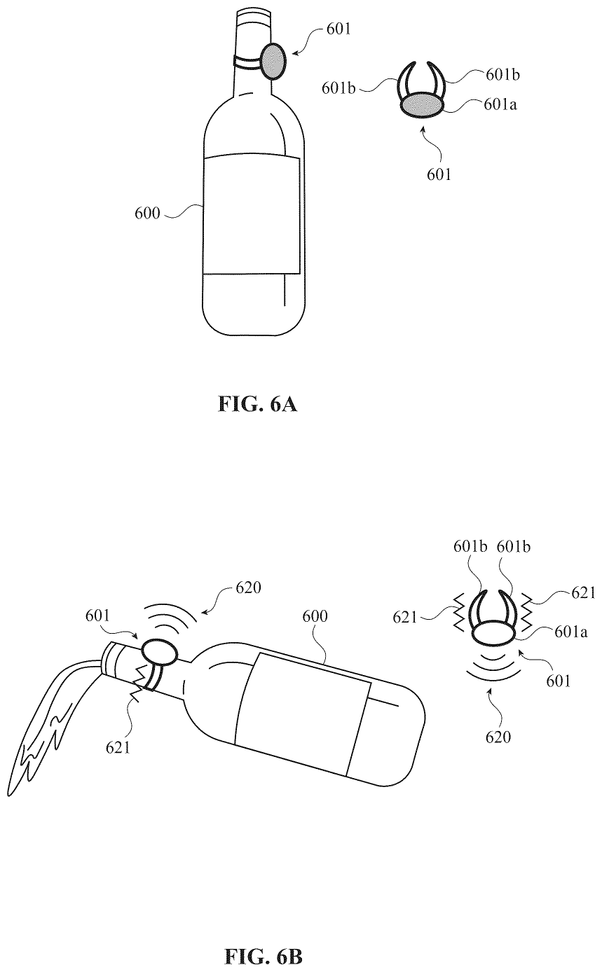

While the previous examples illustrated and described throughout FIGS. 2A-5B emphasize a design tailored for supporting a beverage container (e.g., beverage container 200, 300, 400, 500) as a standalone display piece, another approach focusing on portability and versatility is illustrated in FIGS. 6A and 6B. Instead of serving as a base or stand for the beverage container, this example takes the form of a compact ring, as illustrated in FIGS. 6A and 6B, attached to the neck of beverage container 600. Although primarily described as a ring, the apparatus shown in FIGS. 6A-6B can be implemented in other form factors including geometric or non-geometric shapes (e.g. a cylinder, etc.). Additionally, although a single ring is shown, multiple rings can be used together on the same beverage container or multiple beverage containers, and the output special effects can be synchronized as described below for multiple devices.

In some examples, such as illustrated in FIG. 6A, ring-shaped apparatus 601 designed to be securely affixed around the neck or body of a beverage container 600 is presented. In some examples, the ring-shaped apparatus 601 includes head 602 that optionally houses a computer system as described earlier with reference to system 100 or a simplified computer system with reduced capabilities, depending on user or application needs. For example, the head 602 may include communication circuitry (e.g., communication circuitry 102) and/or input devices (e.g., input device 412/512) configured to receive instructions to perform one or more functions as discussed in further detail below with reference to FIG. 6B. The head 602 may additionally include a light source or a plurality of light sources including one or more characteristics of the plurality of light sources 511 as discussed above with reference to FIGS. 5A-5B. As illustrated by FIG. 6A, the ring-shaped apparatus 601 attaches to the beverage container 600 using either the pressure exerted by arms of ring-shaped apparatus 601, an adhesive mechanism, other suitable fasteners, or any combination thereof. The arms 603 can fully (or at least partially) encircle the neck of the beverage container 600. In some examples, arms 603 can function as two distinct segments, such as is illustrated in FIG. 6A, depending on the model. These arms 603 may be made from a variety of materials, such as silicone, plastic, and/or metal among other possibilities. In some examples, the head 602 houses a computer as discussed above, including orientation sensors (e.g., one or more orientation sensors 116) and optionally integrates features like lights, haptics, buttons, microphones, and speakers to perform outputs in response to an input such as illustrated by FIG. 6B. As illustrated by FIG. 6A, the head 602 may optionally include a light source (or a plurality of light sources) that is not illuminated prior to a detection by the orientation sensors as discussed in further detail below. In some examples, the arms 603 are outfitted with haptic motors, enabling the device or the arms to “wiggle,” in response to the input illustrated by FIG. 6B. In some examples, the haptics of the arms 603 are configured in such a way that the haptic feedback generated may move the beverage container 600 or relative to the beverage container 600 in a vertical, horizontal, circular, or any other direction herein including multiple directions simultaneously.

In some examples, such as illustrated in FIG. 6B, the orientation sensors within head 602 detects a change in orientation corresponding to the beverage container 600 being tilted while the beverage is being poured. In some examples, head 602 detects, via the orientation sensors, the beverage container 600 tilting past a specific threshold corresponding to liquid being poured from the beverage container 600. In some examples, in response to the head 602 detecting the change in orientation, the ring-shaped apparatus 601 can emit various outputs such as a sound 620 (optionally adjustable by the user), haptic feedback 621, light effects of varying color, brightness and intensity (denoted by the change in shading of head 602 between FIGS. 6A and 6b), or a combination of these. These various outputs may be produced by an audio speaker, a haptic module, or a light source disposed within the housing of the head 602 and may be adjustable according to a user input. In some examples, sound 620 may be preprogramed music such as described above with reference to FIG. 4A. In some examples, the ring-shaped apparatus 601 can be operated through multiple inputs, including voice commands, touch, remote controls, or physical buttons, mirroring the control options available for the beverage holder 210, 310, 410, and 510 as discussed above. For example, the ring-shaped apparatus 601 may optionally not produce any of the aforementioned effects in response to detecting the change in orientation unless an input (such as provided by hand 401/501) is directed at head 602 prior to the beverage container 600 being poured. In some examples, the ring-shaped apparatus is further programmed (e.g., using system 100) to cease its special effects (e.g., sound 620, haptic feedback 621, lights) when the ring-shaped apparatus 601 detects that the beverage container 600 in a non-pouring orientation (e.g., upright as illustrated in FIG. 6A). In some examples, a timer (e.g., built in) may be provided within the housing of head 602, allowing effects (e.g., sound 620, haptic feedback 621, lights) to stop automatically after a preset time sufficient to pour the contents of a full bottle. For added customization, a user may additionally program the ring-shaped apparatus 601 to adjust the effects presented based on the beverage container 600 fill level, size, and estimated pouring duration, creating a personalized special effects experience dictated by the brand/shape of the beverage container 600. In some examples, the timer is configured such that the effects are triggered after a predetermined time-period has elapsed. This predetermined time may be dictated by a user input or preset by the firmware of the ring-shaped apparatus 601.

In some examples, the ring-shaped apparatus 601 may be synchronized with one or more secondary ring-shaped apparatuses sharing one or more characteristics of the ring-shaped apparatus 601. In this instance, the synchronization is optionally configured such that when at least one of the ring-shaped apparatuses (such as the ring-shaped apparatus 601) detects a change in orientation and communicates (optionally via communication circuitry 102) to the other ring-shaped apparatuses to output the special effects described above simultaneously. In some examples, the ring-shaped apparatus 601 is in communication with beverage holder 210, beverage holder 310, beverage holder 410, and/or beverage holder 510 (optionally via communication circuitry 102) and may be synchronized in such a manner such that all respective apparatuses output the respective special effects simultaneously (e.g., sound effect, motion effect, light effect) in response to a respective apparatuses detecting one or more of the aforementioned inputs or interactions with the beverage container. In one example, the input or interaction is a change in orientation of a beverage container. In another example, the input or interaction is removal of a beverage container from a beverage holder. In some examples, the special effects produced by the ring-shaped apparatus 601 as described above are controlled via an application stored at a secondary device such as discussed above with reference to beverage holder 310, beverage holder 410, and beverage holder 510.

Therefore, according to the above, some examples of the disclosure are directed to an apparatus for holding a beverage container comprising: a beverage container support configured to receive a beverage container, one or more sensors configured to detect a removal of the beverage container and/or one or more input devices configured to receive one or more inputs, one or more output devices, one or more processors, memory, and one or more programs. The one or more programs are stored in the memory and configured to be executed by the one or more processors. The one or more programs including instructions for: detecting, via the one or more sensors, the removal of the beverage container, and in response to the removal of the beverage container, causing the one or more output devices to perform one or more actions. Additionally or alternatively to the one or more examples disclosed above, in some examples, at least one sensor of the one or more sensors is a pressure sensor configured to detect a change in weight corresponding to the removal of the beverage container. Additionally or alternatively to the one or more examples disclosed above, in some examples, the at least one sensor of the one or more sensors is disposed at an upper portion of the beverage container support, the one or more sensors detecting a weight applied by the beverage container at the upper portion of the beverage container support. Additionally or alternatively to the one or more examples disclosed above, in some examples, the at least one sensor of the one or more sensors is disposed at a lower portion of the beverage container support, the one or more sensors detecting the weight applied by the beverage container at the lower portion of the beverage container support. Additionally or alternatively to the one or more examples disclosed above, in some examples, at least one sensor of the one or more sensors is a light sensor, the at least one sensor of the one or more sensors positioned to emit light and received reflected light from the beverage container, and receiving less than a threshold light level corresponds to the removal of the beverage container. Additionally or alternatively to the one or more examples disclosed above, in some examples, the beverage container support further comprising: a base structure configured to provide a support surface for the beverage container support, and one or more support members extending from the base structure to an upper portion of the beverage container support, wherein at least one input device of the one or more input devices is disposed at one of the one or more support members. Additionally or alternatively to the one or more examples disclosed above, in some examples, the one or more inputs includes at least a first user input and a second user input, and the one or more programs further include instructions for: detecting, via the one or more input devices, the first user input, and in response to detecting the first user input, initiating, via the one or more processors, a detection period, wherein the one or more sensors are configured to detect the removal of the beverage container during the detection period, and detecting, via the one or more input devices, the second user input, and in response to detecting the second user input, ceasing, via the one or more processors, the detection period. Additionally or alternatively to the one or more examples disclosed above, in some examples, the first user input corresponds to a first voice command, and the second user input corresponds to a second voice command. Additionally or alternatively to the one or more examples disclosed above, in some examples, the first user input corresponds to a first press of a button corresponding to at least one input device of the one or more input devices, and the second user input corresponds to a second press of the button corresponding to the at least one input device of the one or more input devices. Additionally or alternatively to the one or more examples disclosed above, in some examples, an output device of the one or more output devices corresponds to one or more light sources, and the one or more programs further include instructions for: in response to the removal of the beverage container, activating the one or more light source. Additionally or alternatively to the one or more examples disclosed above, in some examples, an output device of the one or more output devices corresponds to an audio speaker, and the one or more programs further include instructions for: in response to the removal of the beverage container, activating the audio speaker. Additionally or alternatively to the one or more examples disclosed above, in some examples, an output device of the one or more output devices corresponds to a motion apparatus configured to cause motion of one or more objects in response to the removal of the beverage container. Additionally or alternatively to the one or more examples disclosed above, in some examples, the beverage container support further comprises: a housing, wherein the housing is configured to encapsulate the beverage container, a hinge, and a motor configured to operate the hinge to at least partially open the housing to at least partially reveal the beverage container, the motor operating in response to the one or more input devices receiving the one or more inputs. Additionally or alternatively to the one or more examples disclosed above, in some examples, at least one input device of the one or more input device corresponds to a button.

Some examples of the disclosure are directed to a method performed at a beverage container support including at least one or more sensors and/or at least one or more input devices, one or more output devices, one or more processors, and memory. The method comprises detecting, via the one or more sensors, a removal of a beverage container, and in response to the removal of the beverage container, causing the one or more output devices to perform one or more actions. Additionally or alternatively to the one or more examples disclosed above, in some examples, at least one sensor of the one or more sensors is a pressure sensor configured to detect the removal of the beverage container, the one or more sensors detecting a weight applied by the beverage container. Additionally or alternatively to the one or more examples disclosed above, in some examples, an output device of the one or more output devices corresponds to a light source, the method further comprising: in response detecting the removal of the beverage container, activating the light source. Additionally or alternatively to the one or more examples disclosed above, in some examples, an output device of the one or more output devices corresponds to an audio speaker, the method further comprising: in response to detecting of the removal of the beverage container, activating the audio speaker. Additionally or alternatively to the one or more examples disclosed above, in some examples, an output device of the one or more output devices corresponds to a motion apparatus corresponds to a motion apparatus configured to cause motion of one or more objects in response to the removal of the beverage container. Additionally or alternatively to the one or more examples disclosed above, in some examples, the beverage container support further comprises: a housing, wherein the housing encapsulates the beverage container, a hinge, and a motor configured to at least partially open the housing to at least partially reveal the beverage container, the motor operating in response to the one or more input devices receiving the one or more inputs.

The foregoing has been a detailed description of illustrative examples of the present disclosure. Various modifications and additions can be made without departing from the spirit and scope of this disclosure. Features of each of the various examples described above may be combined with features of other described examples as appropriate in order to provide a multiplicity of feature combinations in associated new examples. Furthermore, while the foregoing describes a number of separate examples, what has been described herein is merely illustrative of the application of the principles of the present disclosure. Additionally, although particular methods herein may be illustrated and/or described as being performed in a specific order, the ordering is highly variable within ordinary skill to achieve methods and apparatuses according to the present disclosure. Accordingly, this description is meant to be taken only by way of example, and not to otherwise limit the scope of this disclosure.

1. An apparatus for holding a beverage container comprising:
a beverage container support configured to receive a beverage container;
one or more sensors configured to detect a removal of the beverage container and/or one or more input devices configured to receive one or more inputs;
one or more output devices;
one or more processors;
memory;
one or more programs, wherein the one or more programs are stored in the memory and configured to be executed by the one or more processors, the one or more programs including instructions for:
detecting, via the one or more sensors, the removal of the beverage container; and
in response to the removal of the beverage container, causing the one or more output devices to perform one or more actions.

2. The apparatus of claim 1, wherein at least one sensor of the one or more sensors is a pressure sensor configured to detect a change in weight corresponding to the removal of the beverage container.

3. The apparatus of claim 2, wherein the at least one sensor of the one or more sensors is disposed at an upper portion of the beverage container support, wherein the one or more sensors detects a weight applied by the beverage container at the upper portion of the beverage container support.

4. The apparatus of claim 2, wherein the at least one sensor of the one or more sensors is disposed at a lower portion of the beverage container support, wherein the one or more sensors detects the weight applied by the beverage container at the lower portion of the beverage container support.

5. The apparatus of claim 1, wherein at least one sensor of the one or more sensors is a light sensor, wherein the at least one sensor of the one or more sensors is positioned to emit light and received reflected light from the beverage container, and wherein receiving less than a threshold light level corresponds to the removal of the beverage container.

6. The apparatus of claim 1, the beverage container support comprising:
a base structure configured to provide a support surface for the beverage container support; and
one or more support members extending from the base structure to an upper portion of the beverage container support, wherein at least one input device of the one or more input devices is disposed at one of the one or more support members.

7. The apparatus of claim 1, wherein the one or more inputs includes at least a first user input and a second user input, and wherein the one or more programs further include instructions for:
detecting, via the one or more input devices, the first user input;
in response to detecting the first user input, initiating, via the one or more processors, a detection period, wherein the one or more sensors are configured to detect the removal of the beverage container during the detection period;
detecting, via the one or more input devices, the second user input; and
in response to detecting the second user input, ceasing, via the one or more processors, the detection period.

8. The apparatus of claim 7, wherein the first user input corresponds to a first voice command, and the second user input corresponds to a second voice command.

9. The apparatus of claim 7, wherein the first user input corresponds to a first press of a button corresponding to at least one input device of the one or more input devices, and wherein the second user input corresponds to a second press of the button corresponding to the at least one input device of the one or more input devices.

10. The apparatus of claim 1, wherein an output device of the one or more output devices corresponds to one or more light sources, and wherein the one or more programs further include instructions for:
in response to the removal of the beverage container, activating the one or more light source.

11. The apparatus of claim 1, wherein an output device of the one or more output devices corresponds to an audio speaker, and wherein the one or more programs further include instructions for:
in response to the removal of the beverage container, activating the audio speaker.

12. The apparatus of claim 1, wherein an output device of the one or more output devices corresponds to a motion apparatus configured to cause motion of one or more objects in response to the removal of the beverage container.

13. The apparatus of claim 1, the beverage container support comprising:
a housing, wherein the housing is configured to encapsulate the beverage container;
a hinge; and
a motor configured to operate the hinge to at least partially open the housing to at least partially reveal the beverage container, wherein the motor operates in response to the one or more input devices receiving the one or more inputs.

14. The apparatus of claim 13, wherein at least one input device of the one or more input device corresponds to a button.

15. A method comprising:
at a beverage container support including at least one or more sensors and/or at least one or more input devices, one or more output devices, one or more processors, memory:
detecting, via the one or more sensors, a removal of a beverage container; and
in response to the removal of the beverage container, causing the one or more output devices to perform one or more actions.

16. The method of claim 15, wherein at least one sensor of the one or more sensors is a pressure sensor configured to detect the removal of the beverage container, wherein the one or more sensors detects a weight applied by the beverage container.

17. The method of claim 15, wherein an output device of the one or more output devices corresponds to a light source, the method further comprising:
in response detecting the removal of the beverage container, activating the light source.

18. The method of claim 15, wherein an output device of the one or more output devices corresponds to an audio speaker, the method further comprising:
in response to detecting of the removal of the beverage container, activating the audio speaker.

19. The method of claim 15, wherein an output device of the one or more output devices corresponds to a motion apparatus corresponds to a motion apparatus configured to cause motion of one or more objects in response to the removal of the beverage container.

20. The method of claim 15, the beverage container support further comprising:
a housing, wherein the housing encapsulates the beverage container;
a hinge; and
a motor configured to at least partially open the housing to at least partially reveal the beverage container, wherein the motor operates in response to the one or more input devices receiving the one or more inputs.
